(19) United States
(12) Patent Application Publication
(10) Pub. No.: US 2024/0104610 A1
(43) Pub. Date: Mar. 28, 2024

(54) System and Method for Repeatedly Donating Funds to a Selected Organization

(71) Applicant: Eluzer Brody, Monsey, NY (US)

(72) Inventor: Eluzer Brody, Monsey, NY (US)

(21) Appl. No.: 17/936,368

(22) Filed: Sep. 28, 2022

(51) Int. Cl. G06Q 30/02; G06Q 20/10

(52) U.S. Cl. CPC G06Q 30/0279; G06Q 20/10

(57) ABSTRACT

A portable donation unit and its method of use in donating funds to a selected organization. The donation unit contains at least one physical button that can be manually depressed by a donor numerous times. The donation unit communicates with an administrative server via a data network. Each time a physical button on the donation unit is depressed, a pre-selected amount of funds is automatically transferred from an account of the donor to the selected organization. No actions by the donor are required at a time of donation other than manually depressing the physical button. Each time the physical button is pressed, a pre-selected amount of funds is donated. The donation is subject to pre-selected transaction variables such as the amount of funds available to the donor, a maximum donation rate, and a maximum donation amount. By using the donation unit, a donor can make a large number of small donations daily.

### BACKGROUND OF THE INVENTION

### 1. Field Of The Invention

In general, the present invention relates to systems and methods of donating money to a selected charity or other such organization. More particularly, the present invention relates to systems and methods that use some physical action as a trigger for the donation of funds.

### 2. Prior Art Description

In the Jewish tradition, there was a designated chamber in the Holy Temple in Jerusalem where people could deposit money earmarked for the poor. Those who had fallen on hard times were able to come there and receive sustenance in a respectable manner. In recent centuries, that tradition lives on through the use of tzedakah boxes. Such boxes are found in many Jewish homes and are called pushkas in Yiddish and kuppa in Hebrew.

Many religious, charitable, and service organizations accept receive donations. Many of these organizations rely upon donations to fund their operational expenses. That is, without donations, the organizations could not continue to operate. Since donations are so important to many organizations, there have been many advertising and marketing techniques used to identify donors and obtain ongoing donations. It has been long understood that people are more willing to make a donation to a cause, if the donation process is simple and fast. This is the secret for the success of tzedakah boxes. Donations are made simply by placing money into a conveniently located box. Understanding that making a donation process simple increases donations, many organizations have created software applications that can be run on smart phones to create a donation. Such software applications typically require a user to scan a QR code or visit a website and make a donation. However, the system is complicated by the user having to enter various identifying information and payment information. Accessing the proper website and entering the proper information takes time and effort that dissuades many potential donors.

One way to avoid the hassle of making a donation is to make a donation when paying for a product or service, such as during checkout at a grocery store. In this scenario, the donor already must make a payment. Consequently, adding a small donation to the sum due takes little extra effort. Donation systems that operate at checkout are exemplified by U.S. Pat. No. 9,076,167 to Sobbani and U.S. Patent Application Publication No. 2007/0034681 to Kamiya.

Limiting the time of donations to the time of purchase at checkout does have some disadvantages. Many organizations would like to conduct donation campaigns around life events. For example, it would be very beneficial for an Audubon society to ask that that individuals make a donation every time they see a particular type of bird. Likewise, it would be beneficial to a synagogue, mosque, or church if they could ask members to make a donation every time they pray. However, for such donation systems to work, there must be a way to make a donation that is portable and take no substantial effort on the part of the donor.

In the prior art, there are no electronic donation systems that serve the same simple purpose as does a tzedakah boxes. The closest donation systems are software applications on smart devices that take significant time and thought of mind to operate. A need therefore exists for a donation system that enables a person to make a donation at any time, in any place, and requires no more presence of mind and/or time than it takes to press a button. This need is met by the present invention as described and claimed below.

### SUMMARY OF THE INVENTION

The present invention is a portable donation unit and its method of use in donating funds to a selected organization. The donation unit contains at least one physical button that can be manually depressed by a donor numerous times. The donation unit communicates with an administrative server via a data network.

Each time a physical button on the donation unit is depressed, a pre-selected amount of funds is automatically transferred from an account of the donor to the selected organization. The physical button can be pressed multiple times to make multiple donations. No actions by the donor are required at a time of donation other than manually depressing the physical button.

Each time a physical button is pressed, a pre-selected amount of funds is donated. The donation is subject to pre-selected transaction variables. The pre-selected transaction variables include the amount of funds available to the donor, a maximum donation rate, and a maximum donation amount. The donation is completed each time a physical button is pressed provided the donation does not fall outside the pre-selected transaction variables. By using the donation unit, a donor can make a large number of small donations daily. In this manner, donation programs can be developed where donors are encouraged to make donations during their day as certain life events occur.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is a schematic showing a single button donation unit and its interaction with outside systems needed in the transfer of funds from a donor to an organization;

FIG. 2 is a block diagram outlining an exemplary method of operation for the exemplary embodiment of FIG. 1;

FIG. 3 is a schematic showing a multiple button donation unit and its interaction with outside systems needed in the transfer of funds from a donor to one of a polarity of organizations; and

FIG. 4 shows an alternate embodiment for a donation unit.

### DETAILED DESCRIPTION OF THE DRAWINGS

Although the present invention donation system and methodology can be embodied in many ways, only a few exemplary embodiments are illustrated. The exemplary embodiments are being shown for the purposes of explanation and description. The exemplary embodiments are selected in order to set forth some of the best modes contemplated for the invention. The illustrated embodiments, however, are merely exemplary and should not be considered as limiting when interpreting the scope of the appended claims.

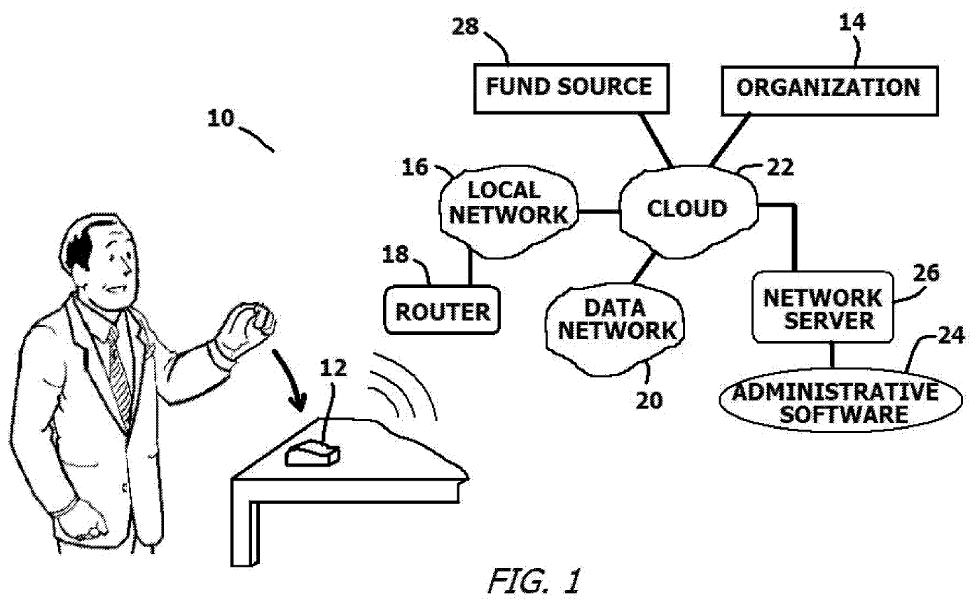

Referring to FIG. 1, a unique system 10 for making a donation is shown. The system 10 consists of a physical donation unit 12 that can be pressed, tapped, flipped, squeezed, or otherwise affected with manual force. Each time the donation unit 12 is touched or otherwise manipulated with manual force, a donation for a specific amount is automatically made to a selected organization 14. In this manner, a donation can be made to the selected organization 14 without an individual having to access a smartphone or computer and without the individual having to access his/her wallet. Rather, the person need only physically interact with the donation unit 12. Preferably, the interaction is a simple tapping of the donation unit 12. This activity takes less than one second and requires little presence of mind to accomplish.

The donation unit 12 can be placed anywhere in a home, office, store, or vehicle. In this manner, the donation unit 12 can be made highly accessible. For example, suppose a person would like to make a donation to a religious organization every time that person catches himself/herself swearing or every time the individual says a prayer. Using the donation unit 12, that person need only touch the donation unit 12 and the donation is automatically made.

The donation unit 12 is a small portable unit that can be carried in a pocket, placed on a table, or mounted to a wall. The donation unit 12 can be battery powered and/or can be charged with a wall plug. The donation unit 12 communicates wirelessly with a data network 16. If the donation unit 12 is in a building with a router, then the data network 16 is local. The donation unit 12 can communicate with a router 18 using a Bluetooth® connection or a Wi-Fi connection. Alternatively, the donation unit 12 can be provided with a SIM card to communicate with a cellular network 20, should a local network be inaccessible. Regardless of network used, the donation unit 12 communicates, via a computer cloud system 22, with administrative software 24 being run on one or more servers 26. As will be explained, the administrative software 24 initiates a transfer of funds from a selected fund source 28 to the selected organization 14 each time the donation unit 12 is activated. The fund source 28 can be a bank account, brokerage account, trust fund account, or credit card account. The organization 14 can be any organization, person or place that accepts donations. If the organization 14 qualifies as a charity under applicable tax regulations, an electronic receipt is generated by the administrative software 24 for each donation for tax filing purposes.

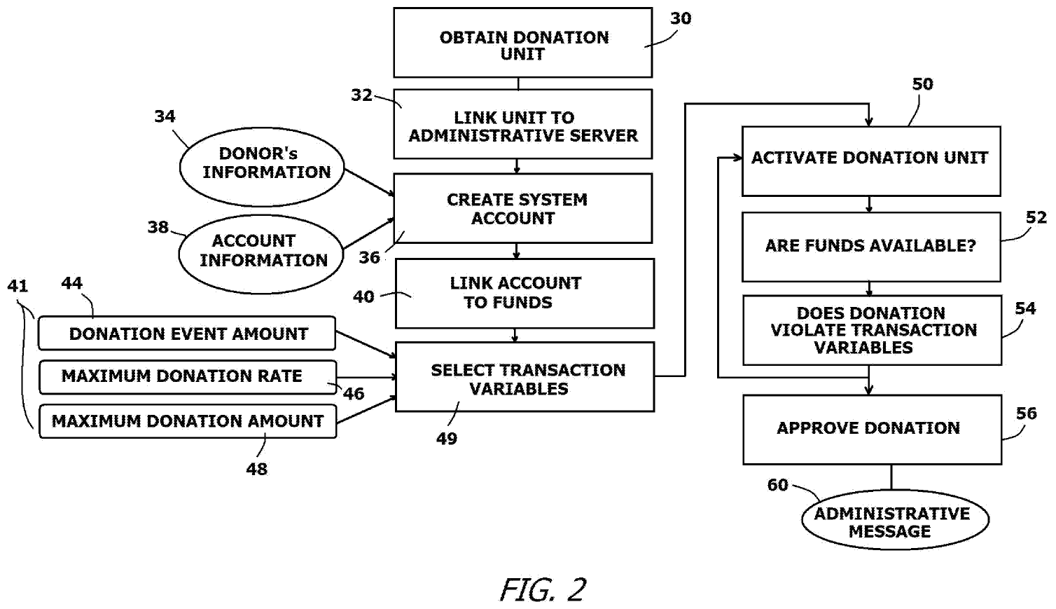

Referring to FIG. 2 in conjunction with FIG. 1, it can be seen that the user of the system 10 obtains a donation unit 12. See Block 30. The donation unit 12 can be purchased for use with any charitable organization. Alternatively, the donation unit 12 can be obtained from a specific organization already preprogrammed to facilitate donations to that charitable organization. For purposes of discussion, it is assumed that the donation unit 12 is being purchased without a preset charitable organization. The purchaser buys the donation unit 12 and links the donation unit 12 to the administrative server 26 via a data network 16. See Block 32. Once linked, the operational parameters for the donation unit 12 are selected. The purchaser enters the donor's information 34. The donor's information 34 includes the donor's name and address. Passwords are set and the system account is created. See Block 36. Once a system account is created, the user enters and links account information 38 to a funds source 28. See Block 40. The account information 38 can be a bank account number, credit card number or the like. The account information enables funds to be electronically withdrawn from the selected account and transferred to a receiving account of the organization 14.

In addition to providing the account information 38, the donor selects certain transaction variables 41. See Block 42. The transaction variables 41 include donation event amount 44, a maximum donation rate 46, and a maximum donation amount 48. The donation event amount 44 is the amount of funds donated each time the donation unit 12 is activated. For example, a donor may setup the donation unit 12 to donate ten dollars each time it is activated. Accordingly, the donation event amount 44 is set at ten dollars. The maximum donation rate 46 sets a maximum amount of funds that can be donated in a selected period of time. For example, a donor may select a maximum donation rate 46 of fifty dollars per hour. This would enable a person to activate the donation unit 12 five times in one hour, assuming each activation donated ten dollars. The maximum donation rate 46 is a safety feature that prevents a child or other unauthorized person from pressing the donation unit 12 excessively. Likewise, the maximum donation rate 46 prevents the donation unit from being accidently activated in a pocket or in the cushions of a couch.

The maximum donation amount 48 selected for the donation unit is another safety feature. The maximum donation amount 48 can be selected for the day, week, month and/or year. In this manner, if a donor would like to limit donations to $1000 dollars per month, then the donation unit 12 will automatically stop donations once this maximum value has been achieved.

Once the account information 38 and the transaction variables 41 are set, the donation unit 12 is ready for use. See Block 49. To use the donation unit 12, the donation unit 12 is pressed or otherwise manually manipulated to begin a transaction. See Block 50. The donation unit 12 communicates with the administrative software 24 running on the server(s) 26. The administrative software 24 first checks that the funds are available for donation. See Block 52. For example, if a person is donating ten dollars from a bank account, the administrative software 24 checks if the bank account has a balance of at least ten dollars. The administrative software 24 then checks the donation against the preselected transaction variables 41. See Block 52. The donation cannot exceed the maximum donation rate 46 nor the maximum donation amount 48. If neither the maximum donation rate 46 nor the maximum donation amount 48 are exceeded, then the donation is approved. See Block 54 and Block 56. The donated funds are then transferred to the selected organization. If funds are unavailable or if either the maximum donation rate 46 or the maximum donation amount 48 are exceeded, then the donation is denied. See loop line 58.

The administrative software 24 can generate messages 60 regarding donations made and/or donations denied. These administrative messages 60 can be sent to the donor via email, text and/or automated phone call. In this manner, a donor can be informed that a donation request has been received and processed. Likewise, a donor can access account information 38 using a computer, smartphone, or similar device to obtain account information 38 for administrative and tax purposes.

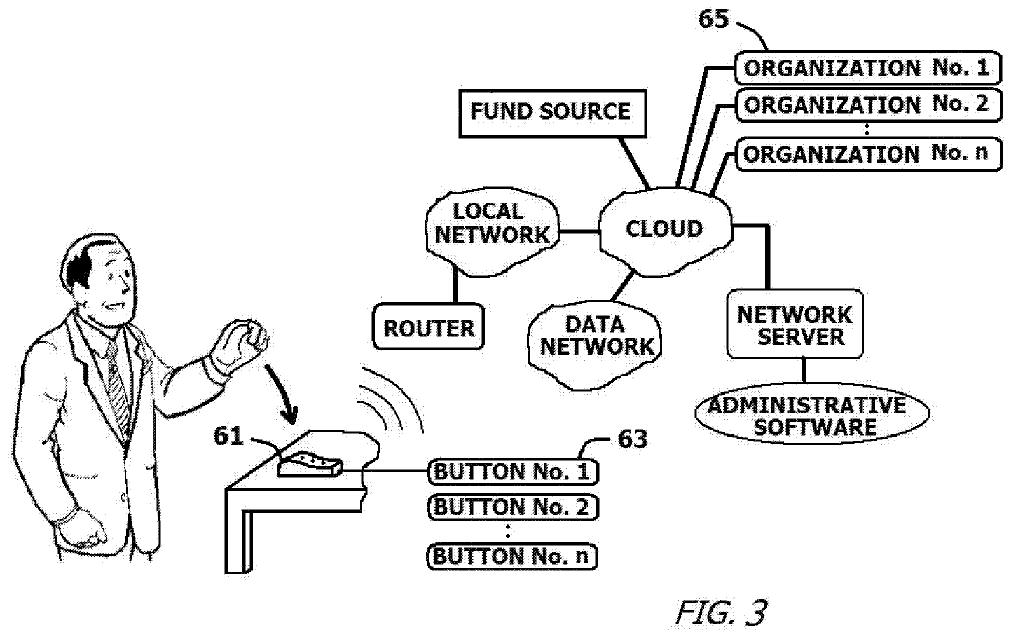

In the embodiment of FIG. 1 and FIG. 2, a donation unit 10 with a single activation button is described that makes a donation to a single organization 14 when activated. Referring to FIG. 3, it will be understood that a donation unit 61 can be provided that contains more than one activation button 63. Each activation button 63 is dedicated to a different organization 65. In this manner, a donor can make donations to more than one organization using the donation unit 61. Different transaction variables can be set for each of the buttons 63. As such, each organization 65 can have a different per-transaction donation amount, maximum donation rate and maximum donation amount.

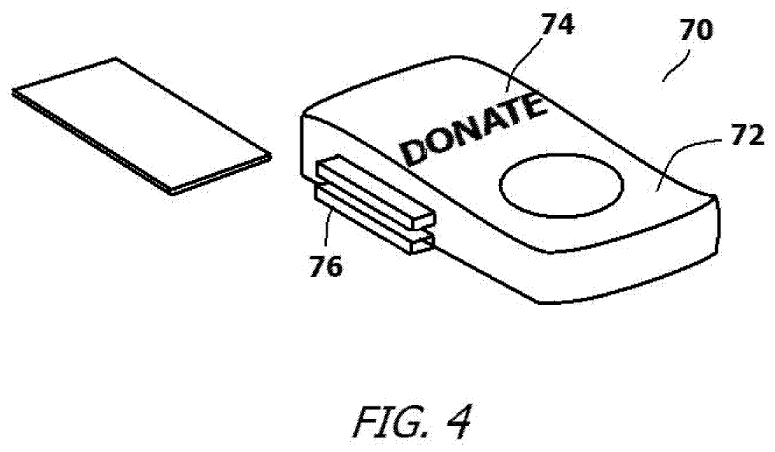

Referring to FIG. 4, another embodiment of a donation system 70 is described. In the embodiment of FIG. 4, a donation unit 72 is provided that is activated by being pressed. However, the donation unit 72 is preprogrammed to donate funds to a specific organization. The donation unit 72 may contain graphics 74 that identify the dedicated organization. The donation unit 72 can be given away or sold by various religious and/or service organizations to individuals who are likely to contribute.

The donation unit 72 contains a card reader 76 that can receive and read the information from a credit card or bank card. Once the card information is read, the donation unit 72 will automatically withdraw a donation from the related account and forwarded the same to the selected organization, each time the donation unit is activated.

It will be understood that the embodiments of the present invention that are illustrated and described are merely exemplary and that a person skilled in the art can make many variations to those embodiments. All such embodiments are intended to be included within the scope of the present invention as defined by the appended claims.

1. A method of donating funds to a selected organization, comprising the steps of:
providing a donation unit that communicates with a data network, wherein said donation unit contains a physical button that can be manually depressed by a donor; and
automatically transferring a pre-selected amount of funds from an account of said donor to said selected organization each time said physical button is manually depressed, wherein no other actions are required at a time of donation other than manually depressing said physical button.

2. The method according to claim 1, wherein said transferring of said pre-selected amount of funds is subject to pre-selected transaction variables.

3. The method according to claim 2, wherein said pre-selected transaction variables include funds available in said account of said donor, a maximum donation rate and a maximum donation amount.

4. The method according to claim 3, wherein said donation unit communicates with a server via said data network, wherein said server runs administrative software.

5. The method according to claim 4, wherein said donor utilizes said administrative software to set values for said maximum donation rate and said maximum donation amount.

6. The method according to claim 5, wherein said donor accesses said server through said data network using a computing device other than said donation unit.

7. The method according to claim 1, wherein
said donation unit contains a card reader and said method includes reading a card supplied by said donor to access said funds of said donor.

8. The method according to claim 1, further including linking said donation unit to an administrative server via said data network;
creating a system account for said donor that contains fund account information, a donation event amount, a maximum donation rate and a maximum donation amount; and
automatically transferring funds equal to said donation event amount to said selected organization each time said physical button on said donation unit is manually depressed, wherein no other actions by said donor are required at a time of donation other than manually depressing said physical button.

9. The method according to claim 8, wherein said maximum donation rate limits the number of times said physical button can be depressed and a donation made, within a selected period of time.

10. The method according to claim 1, wherein said donation unit contains additional physical buttons that can be manually depressed by a donor;
linking said donation unit to an administrative server via said data network;
creating a system account for said donor for said physical button and said additional physical buttons, wherein each said system account contains fund account information, a donation event amount, a maximum donation rate and a maximum donation amount; and
automatically transferring funds equal to said donation event amount to said selected organization each time said physical button or one of said additional physical buttons on said donation unit is manually depressed, wherein no other actions by said donor are required at a time of donation other than manually depressing said physical button or one of said additional physical buttons.

11. The method according to claim 10, wherein said maximum donation rate limits the number of times said physical button or each of said physical buttons can be depressed and a donation made, within a selected period of time.

12. The method according to claim 10, wherein said donation unit communicates with a server via said data network, wherein said server runs administrative software.

13. The method according to claim 12, wherein said donor utilizes said administrative software to set values for said maximum donation rate and said maximum donation amount.

14. The method according to claim 13, wherein said donor accesses said server through said data network using a computing device other than said donation unit.
